(19) United States
(12) Patent Application Publication
(10) Pub. No.: US 2002/0152149 A1
(43) Pub. Date: Oct. 17, 2002

(54) Method and system for transmitting stock price information, information database therefor, server for detecting conditions and client terminal

(76) Inventors: Nensuke Tanaka, Tokyo (JP); Katsuyuki Ishii, Tokyo (JP)

Correspondence Address: FINNEGAN, HENDERSON, FARABOW, GARRETT &, DUNNER LLP, 1300 I STREET, NW, WASHINGTON, DC, 20005, US

(21) Appl. No.: 10/031,229

(22) PCT Filed: May 18, 2001
(86) PCT No.: PCT/JP01/04179

(30) Foreign Application Priority Data
May 18, 2000 (JP) 2000-146945

(51) Int. Cl. G06F 17/60

(52) U.S. Cl. 705/35

(57) ABSTRACT

The system is composed the notification information data base 26 for storing conditions concerning notification of the stock price of a specific name input from a customer terminal connected to the network 21 and the customer's mail address in correspondence to each other, the stock price storage server 27 for updating and storing the stock price of the specific name on the market, the condition detection server 28 for detecting whether the conditions stored in the notification information data base are satisfied or not using the stock price of the specific name stored in the stock price storage server, and the stock price notification mail server 29 for transmitting, when the condition detection server detects that the stock price of the specific name satisfies the conditions, electronic mail to the customer mail address corresponding to the conditions.

### TECHNICAL FIELD OF INVENTION

The present invention relates to a method and system for transmitting information concerning stock prices to a customer from a stock company.

### BACKGROUND ART OF INVENTION

When a customer buys and sells stocks, how the stock price is changing it is naturally important to know. However, in many cases, a customer has work to do and it is very difficult to always monitor a trend of the stock price.

For example, when a customer intends to sell a name of current market value 1000 yen at present at 1200 yen, it is necessary to ascertain the stock price to give an order timely. There are some methods available for ascertaining the stock price, and they are mostly of a type of “inquiring a person in charge of a stock company by telephone”, “browsing by Internet”, or “going to the counter”, and burdens of money and time are imposed on the customer not a little in all cases. Confirmation for a stock company by telephone or by Internet require charges for telephone calls and communication expenses and moreover, changes in the stock price cannot be seized without frequent confirmation.

For example, if confirmation by telephone is made every 30 minutes temporarily, a desired price may be set instantaneously during the said period and then it may be returned to its original price. Further, even if notification of agreement of conditions is requested for a person in charge of a stock company by telephone, there is a type of customer and when a person in charge is out, notification cannot be received timely.

Particularly, for a customer having work to do in the daytime, it is difficult not only to monitor the stock price but also to receive telephone communication from a person in charge of a stock company. There are many companies prohibiting online trade in an office and confirmation of the stock price by Internet cannot be often made satisfactorily.

Even if it is intended to give an order beforehand, there is a limited value range such that the dealable price range on the day is up to ∘∘ yen below or above the stock price on the previous day, so that an order at a price above the limit value range cannot be given. Even if an order can be given, at the point of time when the stock price actually reaches the desired price, there is a case that it is intended to restudy the buying and selling with reference to the market environment and there are many customers hesitating to give an order as it is.

Further, stock price check is required by almost every customer regardless of the investment situation. On a customer investing in many individual stocks, a large burden is imposed for always checking stock prices of all stocks holding. On the other hand, customers, who are not conscious of stock prices generally and intend to invest if stock prices are getting lower greatly judging from the viewpoint of a long period of time, often lose investment chances because of being unconscious of stock prices usually.

On the other hand, viewed from a stock company, when inquiries about stock prices are frequently made from a customer, much time is taken for correspondence with them. Further, even if a customer requests to be notified in agreeing with conditions if any, a person in charge may have business of receiving other customers visits and dealing with them at the counter and cannot monitor stock prices in real time, and thus notification omission may be caused when the number of requested items increases.

Further, a stock price notification system which offers stock price information changing every moment in being accessed from customers is opened (Japanese Unexamined Patent Heisei 11-39400). However, in this case, stock price information is known by access, and to know fluctuations in stock price in detail, frequent access is required, and moreover, information on not only noticeable individual stocks for him but also other individual stocks is received, thus the system is inefficient and very inconvenient.

As mentioned above, in the conventional notification method for information on stock prices, customers are not satisfied and the information provider cannot offer information on stock prices efficiently. Therefore, the present invention is intended to solve the aforementioned problems and to provide a method and system for making customers satisfy and efficiently transmitting information on stock prices by the information provider.

### DISCLOSURE OF INVENTION

The present invention is characterized by providing an information to the customer just when the conditions of noticeable individual stock is satisfied with those to be input beforehand, such as the time when a stock price is changed into the special stock price. The present invention is also characterized in that one or more conditions on various technical indexes such as not only rising and falling of stock prices but also comparison with the stock prices on the day before, the deviation rate from the transfer mean value, and RSI obtained from the psychological line can be input.

Therefore, fine conditions can be input and stock price information can be transmitted and received efficiently for both customers and notifier side. To accomplish the above object, the present invention provides a stock price information transmission method comprising a stock price update step of successively updating and storing information on stock prices, a condition input step of inputting one or more conditions concerning stock prices to be notified to a customer, a condition detection step of detecting whether the stock price updated by the stock price update step satisfies the one or more conditions input by the condition input step or not, and a notification step of, when the conditions are satisfied at this step, notifying the customer of the satisfaction.

Therefore, the customer is notified when the conditions are satisfied, so that the method is efficient for both the customer and notification stock company.

Further, the present invention provides a stock price information transmission method comprising a stock price update step of successively updating and storing information on stock prices, a condition input step of inputting conditions concerning stock prices to be notified to a customer, a condition detection step of detecting whether the stock price updated by the stock price update step satisfies the one or more conditions input by the condition input step or not, and a notification step of, when the one or more conditions are satisfied at this step, notifying the customer of the satisfaction by electronic mail.

The customer is notified by electronic mail, so that he can know the satisfaction early and make judgment of buying and selling of stocks prior to others.

Further, the present invention provides a stock price information transmission method comprising a stock price update step of successively updating and storing information on stock prices, a condition input step of inputting one or more conditions of the technical index concerning the stock price trend of the individual stock to be notified to a customer, a condition detection step of detecting whether the stock price updated by the stock price update step satisfies the one or more conditions input by the condition input step or not, and a notification step of, when the one or more conditions are satisfied at this step, notifying the customer of the satisfaction by electronic mail.

Therefore, the customer can obtain the stock price information transmission method for inputting fine notification conditions.

Further, the present invention can provide a notification information data base having a condition file for storing one or more conditions concerning the name code input from the customer terminal and the stock price of the individual stock to be notified and a notification destination file for storing the notification destination to be notified when the conditions are satisfied.

Therefore, the customer can efficiently store the notification conditions to be input so as to receive notification.

Further, the present invention provides a condition detection server composed of a means for temporarily storing one or more conditions concerning the stock prices input from a customer, a means for receiving stock price fluctuation information from a stock price information server that stock prices are successively updated and confirming whether the conditions concerning stock prices are satisfied or not, and a means for outputting, when the one or more conditions are satisfied, the satisfaction.

Therefore, a server for efficiently detecting whether the notification conditions are satisfied or not is obtained.

Further, the present invention can provide a customer terminal for transmitting and receiving stock price information which displays the screen for promoting to input one or more conditions concerning stock prices, transmits the conditions input on the screen, and when the input conditions are satisfied, receives information of the satisfaction by electronic mail.

Therefore, the customer terminal for inputting one or more conditions concerning the stock prices to be notified to the customer can be obtained. According to the present invention, when the stock price condition of the specific name is input from the customer and when the condition is satisfied, the satisfaction is notified, so that the stock price information can be transmitted and received efficiently for both the customer and stock company.

Further, the present invention can provide a transmission system for stock price information composed a notification information data base for storing technical conditions concerning notification of the stock price of a specific name input from a customer terminal connected to a network and the customer's mail address in correspondence to each other, a stock price storage server for updating and storing the stock price of the specific name on the market, a condition detection server for detecting whether the technical conditions stored in the notification information data base are satisfied or not using the stock price of the specific name stored in the stock price storage server, and a stock price notification mail server for transmitting, when the condition detection server detects that the stock price of the specific name satisfies the technical conditions, electronic mail to the customer mail address corresponding to the technical conditions.

### BRIEF DESCRIPTION OF DRAWINGS

FIG. 1 is a drawing showing the flow of procedure in an embodiment of the present invention.

FIG. 2 is a drawing showing an example of the constitution of an embodiment of the present invention.

FIG. 3 is a drawing showing an example of a screen for inputting conditions by a personal computer by a customer in an embodiment of the present invention.

FIG. 4 is a drawing showing an example of a screen for inputting conditions by a portable telephone by a customer in an embodiment of the present invention.

FIG. 5 is a drawing showing contents of electronic mail notified to a customer.

### BEST MODE FOR CARRYING OUT THE INVENTION

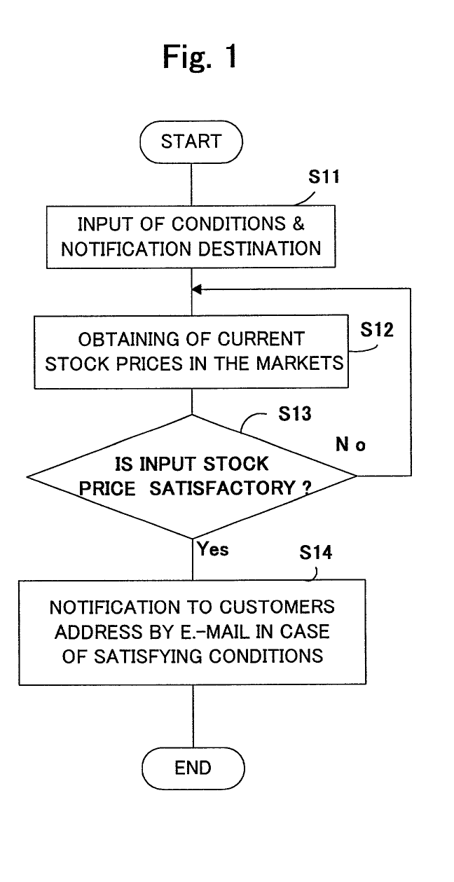

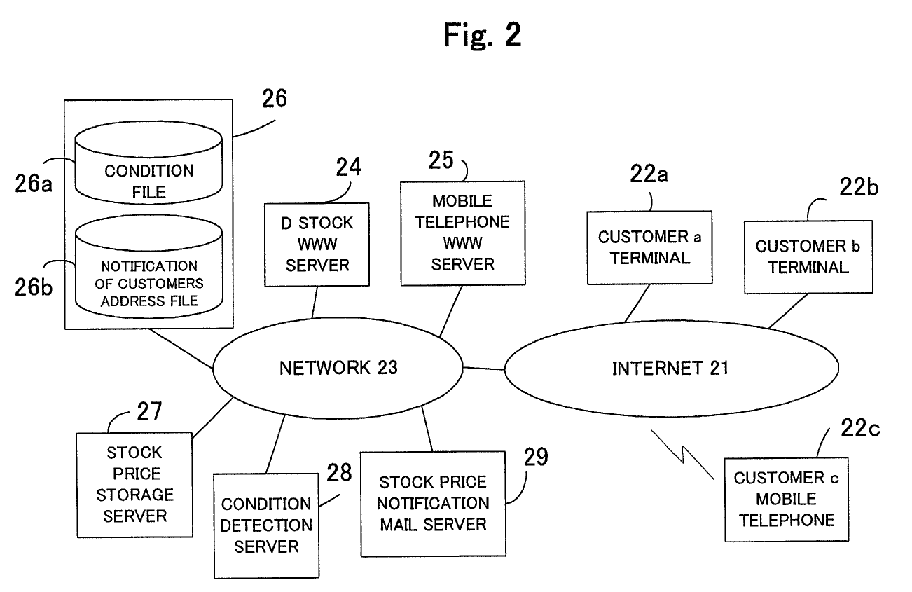

The embodiments of the present invention will be explained hereunder with reference to the accompanying drawings. FIG. 1 is a drawing showing the operation flow for explaining the procedure in an embodiment of the present invention and FIG. 2 is a drawing showing a system configuration example of an embodiment of the present invention.

In FIG. 2, the system is composed of Internet 21, a customer a terminal 22a, a customer b terminal 22b, and a customer c portable telephone 22c which are connected to the Internet 21 respectively and can be accessed by a customer, a network 23 connected to the Internet 21, a D stock WWW server 24 connected to the network 21 for watching the home page of the D stock, a portable telephone WWW server 25 which can be seen by access by an i mode portable telephone, a notification information data base 26 for storing conditions concerning notification of the stock prices input from the customer terminals connected to the network 23 respectively, a stock price storage server 27 for storing each market stock price, a condition detection server 28 for detecting whether the conditions input from the customer terminals are satisfied or not using the current stock prices stored in the server 27, and a stock price notification mail server 29 for transmitting electronic mail to a predetermined notification destination when the conditions input from the server are satisfied.

A customer, from each customer terminal, inputs the name code, the conditions concerning the name to be notified, and the electronic mail destination to be notified. Depending on input of them, the notification information data base 26 has a condition file 26a for storing the name code input by the customer and conditions concerning the name and a notification destination file 26b for storing the notification destination.

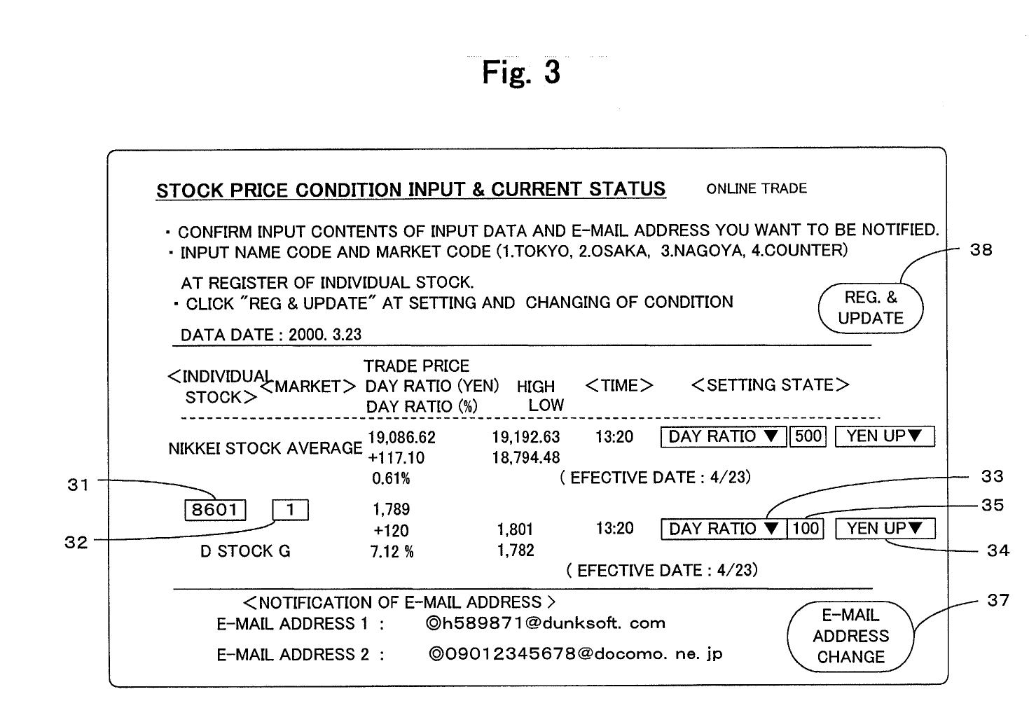

Next, the procedure of this embodiment will be explained by referring to FIG. 1. For example, the customer a is assumed to desire notification when a certain name satisfies fixed conditions. In this case, the customer a connects the own terminal 22a to the Internet 21, accesses the D stock WWW server 24, and watches the home page thereof. The screen in this case, for example, as shown in FIG. 3, is a screen for inputting the name code, market code, stock price conditions, and designated notification destination and after input, those contents can be confirmed.

The name code is input to an input frame 31 and the market code is input to an input frame 32. In an input frame 33, when the “black triangle” is clicked, “Stock Price” and “Ratio to the day before” can be selected and when the input frame 33 is set to “Stock Price”, in an input frame 34, when the “blacktriangle” is clicked, “Above yen” or “Below yen” can be selected. When the input frame 33 is set to “Ratio to the day before”, in the input frame 34, when the “black triangle” is clicked, “Yen rising”, “Yen falling”, “% rising”, “% falling”, “Yen fluctuation”, and “% fluctuation” can be selected.

In an input frame 35, an positive integer of a sum of money or percent can be input. Therefore, as conditions to be notified by electronic mail, the following 8 kinds can be selected.

(1) when the stock price rises to˜yen or more,

(2) when the stock price falls to˜yen or less,

(3) when the ratio to the day before rises by˜yen,

(4) when the ratio to the day before falls by˜yen,

(5) when the ratio to the day before rises by˜%,

(6) when the ratio to the day before falls by˜%,

(7) when the ratio to the day before fluctuates by˜yen, and

(8) when the ratio to the day before fluctuates by˜%.

Further as the notification conditions, not only the stock price of a specific name but also, as shown in FIG. 3, change of a Nikkei stock average can be included. In addition, conditions concerning various technical indexes including various indexes such as TOPIX and Nikkei stock futures, comparison with stock prices on the day before (ratio to the day before), the deviation rate from the transfer mean value, and RSI obtained from the psychological line can be input.

The example shown in FIG. 3 is an example of the condition of (3) mentioned above and it is an input screen when notification by electronic mail is required when the ratio to the day before of the Nikkei stock average rises by 500 yen or more or the ratio to the day before of the stock price of the D stock group rises by 100 yen or more.

Further, the period to be notified when the aforementioned conditions are satisfied is set to, for example, 30 days. An input frame is provided and the period can be changed within a predetermined period by inputting in it.

When an electronic mail address is registered already, the address is displayed in the field of designated notification destination. It is clicked and the notification destination is designated. Destination changing button 37 is clicked to change the notification destination. Then, the screen for inputting an electronic mail address appears and the notification destination to which it is to be notified that the stock price conditions are satisfied can be input. As shown in the drawing, a plurality of addresses, for example, an electronic mail address of a general personal computer or an electronic mail address of a portable telephone can be set as notification destinations.

The screen input in this way can be called thereafter by a customer whenever necessary and the present condition at the point of time can be known. Further, the conditions input already can be corrected.

When already notified by electronic mail, instead of the term of validity, the satisfaction of being notified and the notification date are displayed. Concretely, “Term of validity MM/DD”, “Notified MM/DD”, and “Expired MM/DD” are displayed.

Therefore, when a customer forgets the notification conditions desired by him, there is an advantage that he can reconfirm the conditions under which he desires notification. Further, for a customer receiving many electronic mails everyday, there is another advantage that whether already received or not can be checked. The conditions input and set once in this way are displayed on the register screen even in a state of expiration of the term of validity or being notified as long as the customer does not change the registration contents, so that the names can be controlled easily.

Further, the customer can input the conditions for receiving notification by electronic mail not only from a general personal computer terminal but also, for example, from the portable telephone 22c capable of using the i mode of the customer c. Not only the i mode but also a portable telephone capable of accessing the Internet can be used for input of the notification conditions.

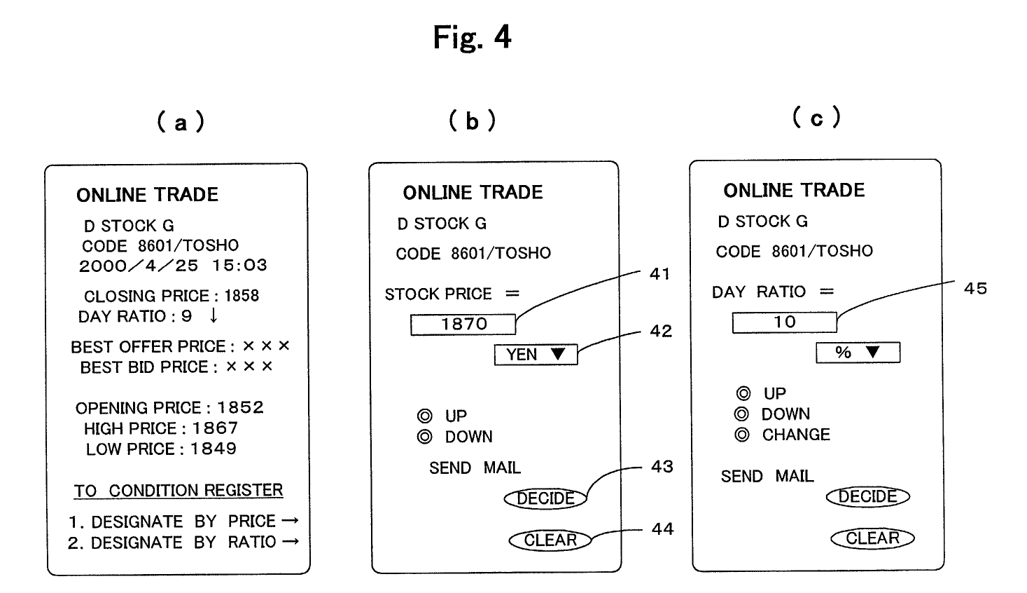

A condition input example is shown in FIG. 4. FIG. 4(a) is a screen for viewing the name trend of the D stock first, and in the field of “To condition registration” on the lower part thereof, when 1 is selected, the screen for inputting the conditions of the stock price shown in FIG. 4(b) appears, and when 2 is selected, the screen for designating the notification conditions by the ratio to the day before shown in FIG. 4(c) appears.

On the screen shown in FIG. 4(b), a numeral is input in the input frame 41, and the conditional stock price is input, and the “black triangle” in the input frame 42 is selected, thus yen and % can be selected. Next, “When above” or “When below” is selected, and the “Decision” button 43 below is clicked, and the notification conditions are transmitted. To clear the input conditions, the “Clear” button 44 is clicked.

When Designation is selected by the ratio to the day before on the screen shown in FIG. 4(a), the notification conditions are input on the screen shown in FIG. 4(c). In this case, other than that the conditions are input by the ratio to the day before, thus the conditions are selected by any of rising, falling, and changing, input and selection are executed in the same way as with FIG. 4(b).

In this way, by a general personal computer terminal or a portable telephone, the name code, stock price conditions, and notification destination are input at step S11 shown in FIG. 1.

When the input ends, by clicking the “Register-Update” button, the conditions concerning the input stock price are transmitted.

The information concerning stock price notification desired by a customer which is transmitted in this way is sent to the notification information data base 26 via the Internet 21 and the network 25. In the data base, the name code input by the customer and the notification conditions concerning it are stored in the condition file 26a and the mail address to which electronic mail is sent when the conditions are satisfied is stored in the notification destination file 26b.

On the other hand, as shown at Step S12 in FIG. 1, in the stock price storage server 27, stock prices of names in the markets such as Tokyo, Osaka, Nagoya, stores, and JASDAC JAPAN are notified and updated every moment.

Next, at Step S13, the conditions desired by the customer are read from the condition detection server 28 and whether the conditions are satisfied or not is detected. Firstly, the name is checked for each condition by the stock name file 26a and then the present stock price of the stock name is checked from the stock price storage server 27. Next, the condition detection server 28 reads the conditions desired by the customer from the condition file in the notification information data base 26 and checks whether the stock price read from the stock price storage server 27 satisfies the conditions.

When the conditions from the customer are not satisfied, the process is returned to Step S12 again and the stock price at this point of time is updated. Whether the conditions input by the customer are satisfied or not is detected, for example, every 10 minutes during the witnessing time. When the detection is executed (time update) every a predetermined time like this, the stock price is decided using 4 values a day, so that when it reaches the stock price which is a registered condition already at the point of time of condition registration even once, notification by electronic mail is executed. Further, when the “ratio to the day before” (day ratio) cannot be identified due to ex rights, the setting by the ratio of closing day to the day before is invalid. Further, the stock price for which stock price decision is executed is only the “turnover” and the tone price is invalid.

On the other hand, at Step S13, when it is ascertained that the conditions desired by the customer are satisfied, the process goes to Step S14 and it is notified to the designated notification destination that the conditions reach the conditions that notification is desired by electronic mail.

Namely, when it is detected by the condition detection server that the conditions are satisfied, the notification destination in this case is called from the notification destination file 26b in the notification information data base 26 and the satisfaction that the conditions are satisfied and the electronic mail address information of the notification destination are sent to the stock price notification mail server 29.

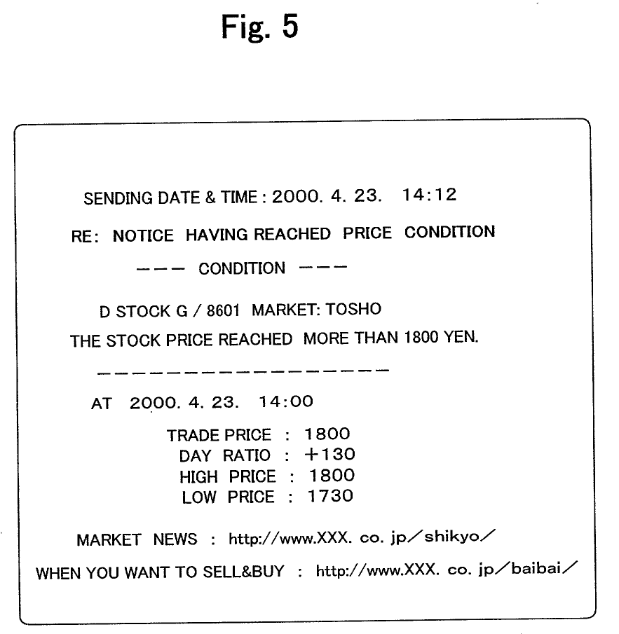

On the basis of this information, the stock price notification server 29 sends mail of the satisfaction that the conditions are satisfied to the designated mail address. An example of the received contents of the electronic mail is shown in FIG. 5.

In the electronic mail, that the conditions reach the stock price conditions of the name whose notification is requested from the user, the present stock price of the name, the present time, the ratio to the day before, and the today' high price and low price are indicated. Therefore, the customer can know not only that the noticeable name reaches a predetermined stock price but also the today's trend of the name and can judge easily whether or not to buy and sell as a whole.

Further, the electronic mail to be notified includes the address of the home page for explaining the general situation of market as a market news. When the address is clicked, the condition of the stock market at this point of time can be known. Therefore, there is an advantage that the customer notified by the electronic mail can confirm not only the condition of the designated name but also the condition of the whole market.

Furthermore, as shown on the lowest part of FIG. 5, in the notified electronic mail, the address of the home page when the name is bought and sold is mentioned and when the address is clicked, the form of the certification screen of the contract for sale is opened. After the certification procedure is executed by this form, the name notified already by the electronic mail and the stock price thereof are input in the form of the contract for sale, and they are input in another part, thus the stock can be bought and sold comparatively simply, and a buy and sell order can be given promptly.

Meanwhile, in the aforementioned embodiment, the mail notification conditions requested from the customer are checked every 10 minutes during the witnessing time. However, the time interval is shortened more, and the notification conditions can be detected almost continuously, and almost in real time for price fluctuations, the notification that the conditions are satisfied can be received.

When the conditions are detected continuously like this, a burden is imposed on detection of the notification conditions, and on the other hand, a case that the conditions reach the notification conditions is discrete from the viewpoint of time, accordingly the mail notification of the customer is also discrete, thus there is an advantage that the burden at the time of mail notification can be lightened. Further, when a perfect real-time process is performed, even if the conditions realized at least once already on the day are set, until the conditions reach that conditions next, the notification is not executed and the price condition such as a tone price is also valid.

In the aforementioned embodiment, as soon as the set conditions are realized, notification by the electronic mail is executed, so that there is no need to always monitor the stock price. Therefore, if a portable terminal such as a portable telephone is used, even a customer having work to do in the daytime can confirm arrival of the conditions easily. Further, the conditions can be registered by a portable telephone of the i mode, so that the set conditions can be corrected whenever necessary at the place where he works or at the place where he is.

In the aforementioned embodiment, electronic mail is used for notification to customers. However, not only electronic mail but also other communication means such as FAX and telephone may be used to notify customers. According to the present invention, sales men in a stock company are included in customers.

### Industrial Applicability

As mentioned above, in the transmission method for stock price information of the present invention, when predetermined conditions are satisfied, the satisfaction is automatically notified to a customer immediately, so that there is no need to always monitor stock prices and the method is useful for him. Moreover, also for the stock price information supplier side, upon receipt of a request from a customer, information is automatically notified to the request customer without monitoring stock prices, so that the method is useful.

1. A transmission method for stock price information, comprising:
a stock price update step of successively updating and storing information on stock prices,
a condition input step of inputting one or more conditions concerning stock prices to be notified to a customer,
a condition detection step of detecting whether said stock price updated by said stock price update step satisfies said one or more conditions input by said condition input step or not, and
a notification step of, when said one or more conditions are satisfied at said condition detection step, notifying said customer of the satisfaction.

2. A transmission method for stock price information, comprising:
a stock price update step of successively updating and storing information on stock prices,
a condition input step of inputting one or more conditions concerning stock prices to be notified to a customer,
condition detection step of detecting whether said stock price updated by said stock price update step satisfies said conditions input by said condition input step or not, and a notification step of, when said one or more conditions are satisfied at said condition detection step, notifying said customer of the satisfaction by electronic mail.

3. A transmission method for stock price information, comprising:
a stock price update step of successively updating and storing information on stock prices,
a condition input step of inputting one or more conditions of a technical index concerning a stock price trend of a name to be notified to a customer,
a condition detection step of detecting whether said stock price updated by said stock price update step satisfies said one or more conditions input by said condition input step or not, and
a notification step of, when said one or more conditions are satisfied at said condition detection step, notifying said customer of the satisfaction by electronic mail.

4. A transmission method for stock price information according to claim 2 or 3, wherein said information notified by said notification step includes said stock price trend of said name.

5. A transmission method for stock price information according to claim 2 or 3, wherein said condition detection step detects whether said input one or more conditions are satisfied or not every a predetermined time.

6. A transmission method for stock price information according to claim 2 or 3, wherein said condition detection step detects almost continuously whether said input conditions are satisfied or not.

7. A transmission method for stock price information according to claim 2 or 3, wherein in said electronic mail notified by said notification step, an address of a home page linked to a current market is mentioned.

8. A transmission method for stock price information according to claim 2 or 3, wherein in said electronic mail notified by said notification step, an address of a home page linked to a certification screen to a stock buying and selling form is mentioned.

9. A transmission method for stock price information according to claim 2, wherein there are a plurality of addresses of said electronic mail notified by said notification step.

10. A notification information data base, comprising:
a condition file for storing one or more conditions concerning a name code input from a customer terminal and a stock price of said name to be notified and
a notification destination file for storing a notification destination to be notified when said one or more conditions are satisfied.

11. A condition detection server, comprising:
means for temporarily storing one or more conditions concerning stock prices input from a customer,
means for receiving stock price fluctuation information from a stock price information server that stock prices are successively updated and confirming whether said one or more conditions concerning stock prices are satisfied or not, and
means for outputting, when said one or more conditions are satisfied, the satisfaction.

12. A customer terminal for transmitting and receiving stock price information, displaying a screen for promoting to input one or more conditions concerning stock prices, transmitting said one or more conditions input on said screen, and when said input conditions are satisfied, receiving information of the satisfacation by electronic mail.

13. A customer terminal for transmitting and receiving stock price information according to claim 12, wherein on a same screen as said input screen, whether said electronic mail to be transmitted when said one or more conditions are satisfied is already transmitted or not is displayed.

14. A customer terminal for transmitting and receiving stock price information according to claim 12, wherein an address of a home page of a predetermined form of stock buying and selling is displayed in contents of said received electronic mail and when said address is clicked, a predetermined name with said one or more conditions input is input and displayed on said predetermined form.

15. A transmission system for stock price information, composing:
a notification information data base for storing one or more conditions concerning notification of a stock price of a specific name input from a customer terminal connected to a network and a customer's mail address in correspondence to each other,
a stock price storage server for updating and storing said stock price of said specific name on a market, a condition detection server for detecting whether said one or more conditions stored in said notification information data base are satisfied or not using said stock price of said specific name stored in said stock price storage server, and
a stock price notification mail server for transmitting, when said condition detection server detects that said stock price of said specific name satisfies said one or more conditions, electronic mail to said customer mail address corresponding to said one or more conditions.

16. A transmission system for stock price information, composing:
notification information data base for storing one or more conditions for a technical index concerning notification of a stock price of a specific name input from a customer terminal connected to a network and a customer's mail address in correspondence to each other,
stock price storage server for updating and storing said stock price of said specific name on a market,
a condition detection server for detecting whether said technical conditions stored in said notification information data base are satisfied or not using said stock price of said specific name stored in said stock price storage server, and
a stock price notification mail server for transmitting, when said condition detection server detects that said stock price of said specific name satisfies said technical conditions, electronic mail to said customer mail address corresponding to said technical conditions.
